(19) United States
(12) Patent Application Publication
(10) Pub. No.: US 2023/0091440 A1
(43) Pub. Date: Mar. 23, 2023

(54) A METHOD AND A SYSTEM FOR IDENTIFYING A SECURITY BREACH OR A DATA THEFT

(71) Applicant: ONGAGE LTD., Tel Aviv (IL)

(72) Inventors: ASSAF BEN ASHER, Ramat Hasharon (IL); OFER SHANI, Mazkeret Batya (IL); KFIR MOYAL, Tel Aviv (IL)

(21) Appl. No.: 17/795,884

(22) PCT Filed: Jan. 20, 2021
(86) PCT No.: PCT/IB2021/050409

§ 371 Date: Jul. 28, 2022

Related U.S. Application Data
(60) Provisional application No. 62/966,040, filed on Jan. 27, 2020.

(51) Int. Cl. G06F 21/55

(52) U.S. Cl. CPC G06F 21/552; G06F 2221/034

(57) ABSTRACT

A method, a system, and a computer program for determining a breach in a computer system, by defining a plurality of first data items, where each data item comprises a link to a content item, forming a plurality whitelisted links, receiving a message item comprising at least one second data item comprising a link to a communicated content item, comparing the links of the second data items with the plurality whitelisted links, and flagging the message as an inadequate message if any of the links of the second data items is not within the plurality of whitelisted links.

### FIELD

The method and apparatus disclosed herein are related to the field of data processing and storage, and particularly but not exclusively, to the security of data processing and storage, and particularly but not exclusively, to the security of data communication, and particularly but not exclusively to security of a data messaging, and particularly but not exclusively, to identifying security breach and/or data theft in a computerized system, data storage system, or a communication system, such as a messaging system.

### BACKGROUND

Data in a computerized system is vulnerable to security breach, and particularly data theft. One aspect of securing a data system is early identification of the security breach, and further, identifying what data has been compromised and who has this data. Address books and similar lists of names and communication addresses are particularly vulnerable being relatively easy to spot, and being immediately useful to the thief. There is thus a widely recognized need for, and it would be highly advantageous to have, a system and method for identifying theft of data, and particularly theft of mailing lists.

### SUMMARY

According to one exemplary embodiment there is provided a method, a system, and a computer program for determining a breach in a computer system, by defining a plurality of first data items, where each data item comprises a link to a content item, forming a plurality whitelisted links, receiving a communicated data item, such as a message, comprising at least one second data item comprising a link to a communicated content item, comparing the links of the second data items with the plurality whitelisted links, and flagging the message as an inadequate message if any of the links of the second data items is not within the plurality of whitelisted links.

According to another exemplary embodiment of the method, system, and/or software, the communicated data item, or message, may be any of an email message, an SMS message, a text message, and a push notification.

According to still another exemplary embodiment, the method, system, and/or software, may additionally provide a messaging address for receiving at least one message by a first message processing server, and enable embedding the messaging address in at least one list of messaging addresses for use by a second message processing server, where the first message processing server is operative to receive the message item being sent by the second message processing server using the list of messaging addresses comprising the messaging address.

According to still another exemplary embodiment, the action of comparing the links may additionally include any one or more of the functions: identifying at least one component of the link, identifying at least one redirection link, tracing a chain of redirection links, and adding a redirection link to the plurality whitelisted links.

Yet according to another exemplary embodiment, the action of comparing the links may additionally include any one or more of the functions:
Obtaining at least one of: at least one link domain to form at whitelist authorized link domains, and at least one link sub-domain to form at whitelist authorized link sub-domains,
Comparing at least one of: a sub-domain of the link with the sub-domain of the whitelist of authorized sub-domains to form a match, and a domain of the link with the domain of the whitelist of authorized domains to form a match, and
The flagging the communicated data may additionally include at least one of: flagging the sub-domain, and flagging the domain.

Unless otherwise defined, all technical and scientific terms used herein have the same meaning as commonly understood by one of ordinary skill in the relevant art. The materials, methods, and examples provided herein are illustrative only and not intended to be limiting. Except to the extent necessary or inherent in the processes themselves, no particular order to steps or stages of methods and processes described in this disclosure, including the figures, is intended or implied. In many cases the order of process steps may vary without changing the purpose or effect of the methods described.

### BRIEF DESCRIPTION OF THE DRAWINGS

Various embodiments are described herein, by way of example only, with reference to the accompanying drawings. With specific reference now to the drawings in detail, it is stressed that the particulars shown are by way of example and for purposes of illustrative discussion of the preferred embodiments only, and are presented in order to provide what is believed to be the most useful and readily understood description of the principles and conceptual aspects of the embodiment. In this regard, no attempt is made to show structural details of the embodiments in more detail than is necessary for a fundamental understanding of the subject matter, the description taken with the drawings making apparent to those skilled in the art how the several forms and structures may be embodied in practice.

In the drawings:

FIG. 1 is a simplified block diagram of a breach detection process;

FIG. 2 is a simplified block diagram of a breach detection and response system;

FIG. 3 is a simplified flow chart of a threat detection and reporting process executed by the breach detection and response system;

FIG. 4A and to FIG. 4B, taken together, are a simplified flow chart of an alternative threat detection and reporting process executed by breach detection and response system;

FIG. 5 is a simplified block diagram of a preparation routine for the breach detection and response system; and

FIG. 6 is a simplified block diagram of an online processing routine for the breach detection and response system.

### DETAILED DESCRIPTION

The present embodiments comprise a method, a system, and a computer program for identifying a security breach and/or data theft in a computerized system, and/or a computerized storage system, and/or communicated data. Particularly but not exclusively, the present embodiments may comprise a method, a system, and a computer program for identifying security breach and/or data theft in in a communication system, and, particularly but not exclusively, in a messaging system.

The principles and operation of the system, method, and computer program for technology transfer and cooperation according to the several exemplary embodiments may be better understood with reference to the following drawings and accompanying description.

Before explaining at least one embodiment in detail, it is to be understood that the embodiments are not limited in its application to the details of construction and the arrangement of the components set forth in the following description or illustrated in the drawings. Other embodiments may be practiced or carried out in various ways. Also, it is to be understood that the phraseology and terminology employed herein is for the purpose of description and should not be regarded as limiting.

In this document, an element of a drawing that is not described within the scope of the drawing and is labeled with a numeral that has been described in a previous drawing has the same use and description as in the previous drawings. Similarly, an element that is identified in the text by a numeral that does not appear in the drawing described by the text, has the same use and description as in the previous drawings where it was described.

The drawings in this document may not be to any scale. Different Figs. may use different scales and different scales can be used even within the same drawing, for example different scales for different views of the same object or different scales for the two adjacent objects.

The purpose of the embodiments is to determine a security breach of a computerized system, such as theft of data, such as an address list, and/or inappropriate and/or unauthorized use of a communicated data, such as data communicated using a computerized messaging system of any type.

The term ‘address list’ may refer to any form of a list of communication destinations such as a list of emails, a list of phone numbers (e.g., for texting), a list of push ID users, etc.

In one embodiment, the method and system described operates as an event detection and response system that monitors, detects, and intercepts breach events that may be caused by hackers, malicious insiders, faulty integrations and employee negligence.

The term ‘breach point’ may refer to any computational means that contains a database or interacts with a datastore or a database. The terms ‘datastore’ and ‘database’ may refer to any collection or storage of computational data.

A typical breach points may involve, for example, any type of data communicated via a computerized system or service, including any type of communication system or service. A communication system or service may include, for example, a messaging system or service such as, for example, an email system or service, a short message service (SMS system or service), a push system or service, etc.

Additionally, a typical breach points may involve a customer resource management system (CRM), a marketing automation platform, a computer server in the customer’s premises or the cloud, internal database and/or remote database, a cloud access point, any software accessing or using database access keys, etc. The term ‘marketing automation’ may include any form and type of electronic and/or digital marketing communication, which may use any type of system or service for communicating data and/or content, such as email, SMS and other means of texting including instant messaging, posting in a virtual social network, etc.

The term ‘honeypot’ may refer to any instance of data that is created and planted in a particular data store for the purpose of identifying a security breach and/or data theft. A honeypot is typically stored in, or in association with, a breach point.

An example of a computerized system may be a communication system of any type, such as a messaging system of any type. The terms ‘communication system’ and ‘messaging system’ may refer to any computerized system that may be used to communicate data, in any form of data.

An example of a messaging system may be an email system. The term ‘email’ may refer to a message, such as an email message, that may be processed by an email system. However, for the purpose of the discussion below, the term email may also refer to any type of message processed by any type of messaging system. For example, the messaging system may be a short message service (SMS), a text messaging service, and a push notification service, and messages thereof.

In this respect, an example of a honeypot is an email address, and/or an email mailbox, that has been created to identify misuse, and/or unauthorized use, and/or inappropriate use, of the honeypot, as well as other data associated with, and/or stored with the honeypot.

Another example of a honeypot may be a ‘standard’ piece of data embedded in a communication, for example, a message, for example and email message. The term ‘standard’ may refer to a piece of data that should be included for example, in all email messages of a particular business entity, or in all email messages associated with a particular marketing campaign, etc. Such standard piece of data may be a URL (universal resource locator) or URI (universal resource identifier) or a similar link to an Internet data entity that may be automatically retrieved by the receiver of the message.

The term ‘whitelist’ may refer to any list of data instances that are determined to be valid data instances and/or authorized data instances. For example, a list of URLs and/or URIs that are valid, and/or a similar standard pieces of data. Hence, a message including a URL and/or URI that is not listed in a whitelist may be considered a misuse, and/or an unauthorized use, and/or an inappropriate use.

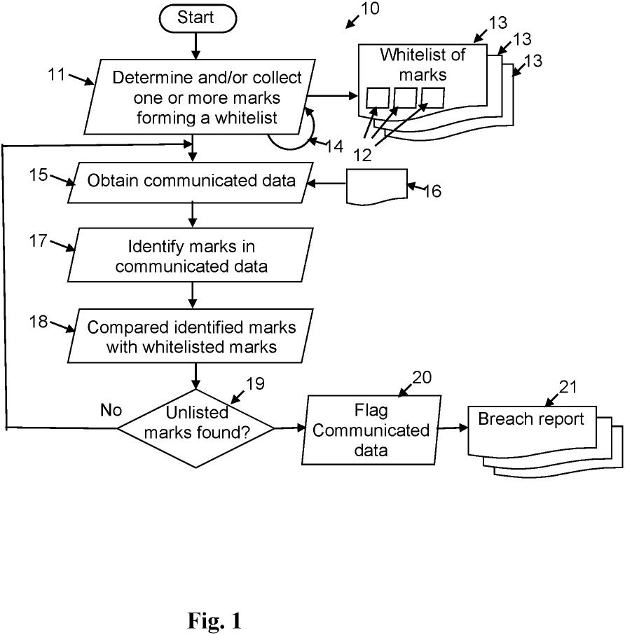

Reference is now made to FIG. 1, which is a block diagram of a breach detection process 10, according to one exemplary embodiment.

Breach detection process 10 may start with action 11 by creating and/or determining and/or collecting one or more marks 12. The term ‘mark’ may refer to any type of a first data item that may be embedded in a second data item. The second data item may be a data record, or a communicated data, such as m for example, a message of any type (e.g., email, SMS, push message, text message, a post, etc. The mark may be any type of binary string, an alphanumeric string, an image, a graphic art, etc. The alphanumeric string may be a URL, URI, etc. The terms ‘communicated data’ or ‘communication’, or message, or record may refer to the second data item carrying an embedded mark.

Action 10 may create the one or more marks. Alternatively, action 10 may scan data items such as the second data items described above to detect embedded marks. Action 10 may then collect the marks in a list of mark that may be denoted a whitelist 13. Such whitelist may include whitelisted marks. Action 10 may create and/or collect one or more whitelists of marks. A mark may be a type of honeypot as described above.

A whitelist and/or the marks of a whitelist may be associated with a subject. The term ‘subject’ here may refer to a business entity, or a section of a business entity such as a department, or an operation of a business entity such as a marketing campaign, or a particular type of data such as a record of a particular database, or a particular type of communication such as email messages, SMS messages, a particular type of multimedia messages, etc. Typically, a particular mark may be mandatory embedded in any data, record, communication, message, etc. of a particular subject.

Action 10 may create marks for each subject. Alternatively, Action 10 may scan data items such as the second data item discussed above, to identify marks embedded in these second data items and associated the identified mark with a respective subject, and/or whitelist associated with the respective subject.

A mark may be visible and/or accessible to a user, such as an image, a graphic art, a URL, a URI, etc. The mark may not be visible and/or accessible to a user such as HTML code. For example, marks 12 may form a plurality of first data items, such as whitelist 13, where each data item (e.g., marks 12) may include a link to a content item, forming a plurality whitelisted links.

It is appreciated that action 11 may be executed repeatedly, or continuously, for example, in the background, as indicated by arrow 14, while process 10 may proceed to executed further actions as detailed below. Hence, process 10 executing action 11 continuously or repeatedly, may collect more marks and whitelists as needed.

Breach detection process 10 may then proceed to action 15 to obtain a communicated data 16. As described above, communicated data 16 may be any type of data record, document, content item, etc., that may include a mark such as the marks described above. Therefore, communicated data item 16 may include at least one second data item (identified mark) including, for example, a link to a communicated content item.

The term obtain in this regard may refer to receiving a message such as communicated data 16. Such message may be received to a messaging address. The term ‘messaging address’ may refer to any kind of communication destination such as an email address, a telephone number used, for example, for SMS or any type of instant messaging application, etc.

Such messaging address for receiving at messages such as communicated data 16 may be provided by a first message processing server or software. In this regard, the messaging address for receiving communicated data 16 may be embedded in one or more lists of messaging addresses that may be commonly and/or regularly used in a normal course of business by a second message processing server or software.

The first message processing server or software may be part of breach detection process 10, while the second message processing server or software may be any type of business support system or software in use by the business entity. It is appreciated that the first message processing server may receive the message item (communicated data 16) sent by the second message processing server using the list of messaging addresses including the embedded messaging address.

Breach detection process 10 may then proceed to action 17 to identify marks in communicated data 16, and then to action 18 to compare the marks identified in communicated data 16 with marks 12 of any of whitelists 13. In this respect, action 18 may compare links of the second data items (identified marks) with the plurality whitelisted links (marks 12).

Breach detection process 10 may then proceed to actions 19 and 20 to determine if a mark identified in communicated data 16 is not whitelisted and flag the communicated data 16 as an inadequate data if any of the links of the second data items is not within the plurality of whitelisted links. Action 20 may then issue a breach report indicating 21, for example, indicating the communicated data 16 associated with the security breach, the one or more identified marks not complying with the whitelisted marks 12, the associated subject (department, campaign, compromised database, etc.), etc.

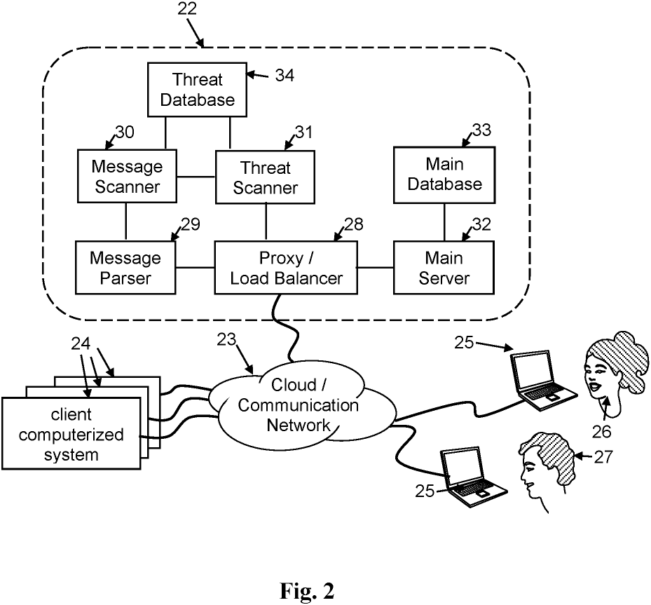

Reference is now made to FIG. 2, which is a flow chart of a breach detection and response system 22, according to one embodiment.

As an option, the block diagram of FIG. 2 may be implemented in the context of the details of the previous figure and/or any subsequent figure(s). Of course, however, flow the block diagram and the breach detection and response system 22 of FIG. 2 may be implemented in the context of any desired environment. Further, the aforementioned definitions may equally apply to the description below.

As shown in FIG. 2, breach detection and response system 22 interfaces with cloud and/or communication network 23, and, via cloud and/or communication network 23, with one or more computerized messaging systems 24, and optionally with consoles 25.

The term `breach detection and response system 22, may refer to any type of computing equipment, including a computer, a server, a cloud processing facility, etc. Such system, or computing equipment, may include at least one processor, as well as one or more memory devices, one or more storage devices, one or more communication devices, one or more user interface devices and/or consoles, etc. The processor of the system, or computing equipment, may execute one or more software programs, which may be embedded in a non-transitory computer readable medium such as the above-mentioned memory and/or storage devices. Such one or more software programs may include modules, and/or subroutines, that may perform functions, or operations, as detailed herein.

The term ‘cloud and/or communication network’ may refer to any type of communication system and/or method and/or service, such as WAN, LAN, PAN, PSTN, PSDN, PLMN, cellular, etc., as well as any computational system and/or method and/or service, such as network servers, provided over, or in association with, any of such network, as well as combinations thereof. cloud and/or communication network 23 may represent any number of such communication networks and cloud services.

The term ‘client computerized system’ may refer to any type of computer system or method that the breach detection and response system 22 monitors to detect security breaches. Particularly, as shown in FIG. 2, client computerized systems 24 may represent an email system of a business party other than the business party operating the breach detection and response system 22 (as well as other than the business party operating the cloud and/or communication network 23).

The term ‘console’ may represent any type of computational equipment and/or user-interface enabling a user to access the breach detection and response system 22. Such console may represent a computer terminal, a personal computer, a laptop computer, a tablet computer, a smartphone, etc. A console 25 may be used by an administrator 26 or a user 27 that that may be employees of the business party operating the breach detection and response system 22 and/or the business party operating the client computerized systems 24.

Breach detection and response system 22 may include the following components:
A proxy server and/or load balancer server 28.
A message parser 29 that may be typically communicatively coupled to the proxy / load balancer 28.
A message scanner 30 that may be typically communicatively coupled to the proxy / load balancer 28 and/or directly to the email parser 29.
A threat scanner 31 that may be typically communicatively coupled to the proxy / load balancer 28 and/or directly to the email scanner 30.
A main server 32 that may be typically communicatively coupled to the proxy / load balancer 28.

Any of the message parser 29, message scanner 30, threat scanner 31, and main server 32 may be connected to a database such as main database 33 communicatively coupled to main server 32, and threat database 34 communicatively coupled to email scanner 30 and/or threat scanner 31.

The term ‘message’ in message parser 29 and/or message scanner 30 may refer to any type of communication software or service including email, SMS, instant messaging, push message service, virtual social networks, etc. The term ‘email’ here may therefore refer to any type of communication or messaging.

A message, such as an email message (email for short) may have a sender identification and/or address, a recipient identification and/or address, and content. The content of an email message may include one or more marks such as links.

The term ‘link’ may refer to any method and/or data item that is used to point to any type of external data. A link may be implemented as an HTTP and/or HTML hyperlink, URL, URI, etc. A computerized system, and/or method, and/or software, such as a messaging system may then use the link to access the external data, either automatically or manually.

An identification and/or address such as a sender identification and/or address and/or a recipient identification and/or address may include an identification of an individual, a department (e.g., sales), a function (e.g., helpdesk) etc., which may be followed by a domain name (domain for short) typically identifying a business entity and/or a messaging service. A typical email address may look like “name@domain”. The term ‘domain’ may therefore represent, or may be associated with, a particular business entity and/or a messaging service. The term ‘whitelist’ may also refer to a list of authorized and/or approved domains.

The term ‘deep linking’ may refer to a situation where a link (embedded link) may be embedded within another link (a first link). For example, the first link may lead to a webpage of a similar data item that may include the embedded link. Thus, the first link automatically forwards the computerized system, and/or method, and/or software, such as a messaging system to the embedded link. There may be any number of links embedded in each other in a sequence or a series embedded links ending with a final link.

Such embedding link may be added by a messaging system intermediating between the original sender and the destination receiver. There may therefore be a string of embedded links (link-string).

Therefore, a whitelisted link may be embedded within another link that may not be whitelisted. For example, the original (whitelisted) link may be replaced by another link, that may redirect the receiver to the original (whitelisted) link.

Further, an email may include a thread of emails preceding the current email, some of which may originate in business entities external to the business entity of the sender of the current email. Such messages from external business entities may include links that are obviously not whitelisted by the current business entity for which the security breach is analyzed.

Therefore, the deep link parser may have to properly identify the source of each link. In the case of an embedded link, the deep link parser may consider the embedding link as a whitelist link if the final link embedded in the link-string is a whitelist link. In the case of an embedded message (a message embedded in a messaging thread), the deep link parser may consider the domain of each message and check honeypots only in messages originating in whitelisted domains.

The main application (software) executed by the main server 23 may provide the following: user graphical user interface (GUI), user authentication and access control, client account management and payment system, breach-point management system, honeypot management system, and a reporting system providing, for example, threat reports.

Particularly, the main application (software/server) 32 may enable a user and/or administrator to set any number of breach-points, to set any number of honeypots, typically associated with a particular breach-point, and embed each honeypot in an address book or a mailing list or a similar data entity.

The main application (software/server) 32 may also enable a user and/or administrator to set any number of whitelists, and to include any particular link, or domain, in one or more of the whitelists. Each such link or domain may have one or more parameters, and the same link or domain may have different parameters in different whitelists.

The parameters associated with the particular link or domain may be used for better identification of the particular link or domain. In this respect, a threat, or a level of threat, may be associated with the parameters not detected. Such parameters that are identified in a particular email message, or are not identified, may be reported in a threat report.

The email parser software executed by the email parser server 32 may be a message driven application, that analyses communications (messages, email messages, etc.) to detect threats. The breach detection and response system 22 may include any number of email parser instances (tasks) according to current email volume. Each time an email arrives in a monitored simple email service (SES) account, a simple queue service (SQS) message is automatically created and received by an email parser task. The email parser then analyzes the email received and creates a threat detection report. Data may be stored in the threats database 34.

The message scanner software executed by the message scanner server 30 may scan other email service providers and interact with external customer resource management systems (CRMs). The email scanner software may generate SQS messages for email parser.

The threat scanner software executed by the email threat scanner server 31 may execute machine vision to analyze images embedded in an email message and collect information thereof, typically using software tools such as optical character recognition (OCR) and similar object recognition software.

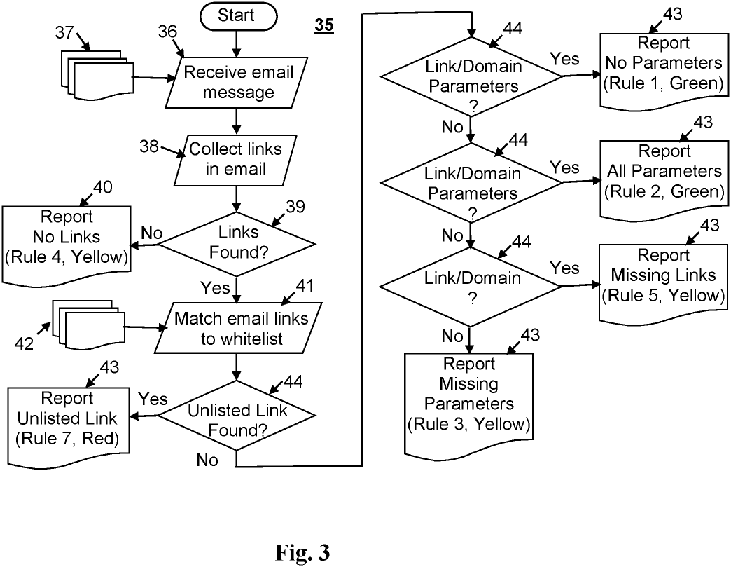

Reference is now made to FIG. 3, which illustrates a flow chart of a threat detection and reporting process (process for short) 35 of software executed by breach detection and response system 22 or any of its modules/servers, in accordance with one embodiment.

As an option, the flow chart/process 35 of FIG. 3 may be implemented in the context of the details of the previous figure and/or any subsequent figure(s). Of course, however, flow chart/process 35 may be implemented in the context of any desired environment. Further, the aforementioned definitions may equally apply to the description below.

The breach detection and response system 22, and/or threat detection and reporting process 35, may process any number of rules such as the following rules:

Rule 1, for example, may determine that a particular data item is (has the status) “Whitelisted” and the threat level may therefore be “Green”. For example, the link or the domain exists in whitelist, and may match a breach point, and may not be associated with a parameter. The report may indicate “A whitelisted email received”.

Rule 2, for example, may determine that a particular data item is (has the status) “Whitelisted” and the threat level may therefore be “Green”. For example, the link or the domain exists in whitelist, and may match a breach point, and all the associated parameters exist in one or more areas of the parsed links in the email retrieved. The report may indicate “A whitelisted email received”.

Rule 3 may determine that a particular data item is (has the status) “Suspicious” and the threat level may therefore be “Yellow”. For example, the link or the domain exists in whitelist, and may match a breach point, and one or more associated parameters do not exist in the parsed links in the email retrieved. The report may indicate “A suspicious email received”.

Rule 4 may determine that a particular data item is (has the status) “Suspicious” and the threat level may therefore be “Yellow”. For example, there is no domain in the email, and/or no parsed links. The report may indicate "A suspicious email received. No links available in the email".

Rule 5 may determine that a particular data item is (has the status) “Suspicious” and the threat level may therefore be “Yellow”. For example, the domain/breach point/parameters processes (of rules 1 and 2) take place, but they do not apply to all the parsed links. For example, in the case of multiple links in the email. The report may indicate "A suspicious email received. Some of the links in the email are not whitelisted".

Rule 6 may determine that a particular data item is (has the status) “Suspicious” and the threat level may therefore be “Yellow”. For example, the domain is found in the whitelist, but it does not match the breach point. The report may indicate "A suspicious email received. Breach point does not match, but domain exists in the whitelist. Please check your honeypot settings".

Rule 7 may determine that a particular data item is (has the status) “Threat” and the threat level may therefore be “Red”. For example, when a different domain is found in the email that does not match the whitelist. For example, a domain or link found in the email is not whitelisted (does not appear in any whitelist). The report may indicate "A suspicious email received. Breach point doesn’t match, but domain exists in the whitelist. Please check your honeypot settings".

It is appreciated that breach detection and response system 22 may include a user interface module enabling a user, such as administrator 26, to modify the set of rules as well as their parameters such as breech severity levels, alarm levels, alarm color types, etc. Therefore, the list of rules presented above is an example of a set of such rules, and the description below may refer to rules that are not listed above, or different breech severity levels, alarm levels, alarm color types, etc., than stated above or presented in the drawings.

For example, a content and/or a message is received for a particular honeypot associated with a particular breach-point that is associated with one or more whitelists. A breach report for the breach-point and/or honeypot may be flagged “Red” indicating, for example, that a link and/or a domain or a similar data-item may be found, and the particular data-item does not exist in any whitelists of any breach point.

If the link/domain/data-item exists in a whitelist of another breach-point than the breach-point associated with the honeypot, the breach report may be flagged as suspicious (“Yellow”).

For example, an unauthorized entity is using a mailing-list stamped with a honeypot may include unauthorized domains (not whitelisted).

Breach detection and response system 22 may enable a user, an administrator, or another software program, to assign one or more unique honeypots to each breach point and multiple whitelist domains to one or more breach-points. It is appreciated that one or more unique sets of honeypots may be assigned to, or identify, aa particular breach point. This may enable breach detection and response system 22 to identify the source of the breach, for example, by using a unique set of honeypots for each breach point.

Hence, the breach detection and response system 22 may combine whitelisting capability with AI-based deep link parser and segmentation logic to identify each email received according to the associated one or more honeypots. Hence, the breach detection and response system 22 may determine a type (level) of alert and associated information as described above. Thus, avoiding false-positive detection.

To achieve such goals the breach detection and response system 22 may employ signature identification of the incoming emails, and the number of times they appear in the honeypot. Hence, determining if the incoming email is a one-time hit, a newcomer, a new “signature”, or is a part of a series of emails that already arrived, therefore enabling identification of a new activity, or a repeated activity.

The deep linker engine may enable the parser to crawl within all the redirection (embedded) links and reach the final destination link and compare it with the whitelisted links and domains according to the various rules.

For example, there may be other platforms and services that may intervene between the time the email is generated by the sender in the email service provider and until it reaches the inbox of the recipient. Such intervening platforms and services may modify the content or code of an email message, which may affect the honeypot. For example, by way of link wrapping (embedding), placing the original link set by the mailer behind another link of the ‘redirecting’ system. To resolve this issue, the deep linker investigates the chain of embedded links, identifies each link in the chain of links, and then reaches a decision, using the relevant rules and based on the whitelisted links.

The breach detection and response system 22 may also analyze other parts of the email message, such as the header, which may contain certain ‘keys’ and ‘hashes’ generated by the sender(s) of the email, and/or their relevant platforms. The breach detection and response system 22 may therefore identify these parameters as well, and use them for determining good and/or bad identification. In this respect, the header content is also placed in a respective whitelist. Therefore, determining a threat and/or a threat level may also depend on ‘sender IP/domain’ and/or ‘sender technology’ and/or ‘sender name’, etc.

As shown in FIG. 3, process (flow chart) 35 may start with action 36, by receiving one or more data items 37, such as a message, such as an email message. Data item 37 may refer to any type of data item and/or content communicated using any type of communication and/or messaging platform, including SMS, instant messaging, push service, etc. For example, the communicated data 16 of FIG. 1.

It is appreciated that such data item 37 (and/or content and/or message) may be received to one or more particular addresses. Such particular addresses may be embedded in one or more breach points such as address book, mailing list, list of contacts, etc. Each such breach point (address book, mailing list, list of contacts, etc.) may include one or more embedded addresses that may be particular (unique) to the particular breach point. Each embedded address may have a respective mailbox, or a similar software entity for receiving a respective type of communicated items (data, content, message, etc.). Such software entity for receiving communicated items may feed the received communicated data item 37 (data, content, message, etc.) to the appropriate module (action) 36.

Process (flow chart) 35 may then continue to action 38 to analyze the received data item and collect predetermined data such as link(s), domain(s), header information, etc. If no predetermined data (link, domain, header information, etc.) is found (action 39), process (flow chart) 35 may report a particular threat report such as report 40 indicating a suspected data item according to rule 4. Flow chart 35 may indicate ‘link’ but the term link herein may refer to any of link, domain, header information, etc.

Process (flow chart) 35 may then continue to action 41 to determine, for each such predetermined data (link, domain, header information, etc.) if the particular predetermined data appears in a whitelist (such as whitelist 42) of the particular type of the predetermined data. Process (flow chart) 35 may then continue to report (43) threats according to respective rules (44) as shown and described in FIG. 3.

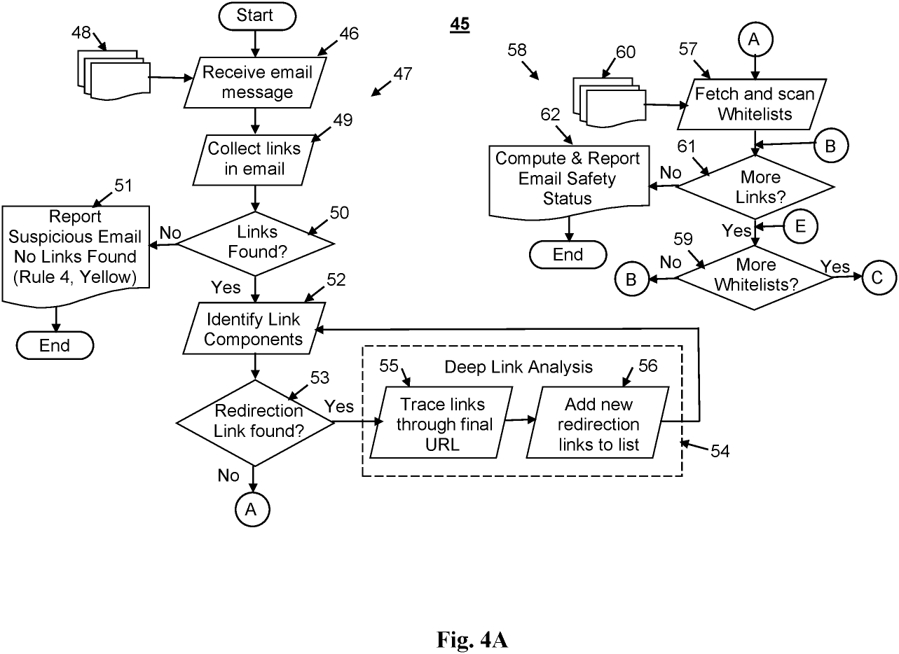

Reference is now made to FIG. 4A and to FIG. 4B, which, taken together, are a simplified flow chart of an alternative threat detection and reporting process 45, that may be executed by breach detection and response system 22, or any of its modules/servers, in accordance with one embodiment.

As an option, the flow chart, and/or threat detection and reporting process 45, of FIGS. 4A and 4B may be implemented in the context of the details of the previous figure and/or any subsequent figure(s). Of course, however, flow chart may be implemented in the context of any desired environment. Further, the aforementioned definitions may equally apply to the description below.

Threat detection and reporting process 45 may start with action 46 of sub-process 47, by receiving one or more data-items 48. Data item 48 may refer to any type of data item and/or content communicated using any type of communication and/or messaging platform, including SMS, instant messaging, push service, etc. For example, the communicated data 16 of FIG. 1. The term ‘link’ herein, as well as the terms link domain (and/or sub-domain), link path, and link parameters, may refer to the term ‘mark’ above. Such links, redirection links, link domain (and/or sub-domain), link path, and link parameters may be authorized and listed in a respective whitelist.

Threat detection and reporting process 45 may then proceed to action 49 to identify and collect links in the received data-item 48. If no links are identified by action 50, a report 51 is issued. The report may indicate the email as suspicious (yellow) for not including any link, for example, according to rule 4.

If a link is found threat detection and reporting process 45 may proceed to action 52 to identify the link’s components. If the link is determined to be a redirection link (action 53), as described above, deep link analysis 54 is invoked to identify and collect the links within the chain of redirection links.

Deep link analysis module 54 may include two actions. Action 55 may trace the links in the link chain until the final link that may be a whitelisted link. Action 56 may add the traced redirection links to the respective whitelist. Deep link analysis module 54 may identify potential threats in the redirect locations of the emails links, for example, by using strategies based on text identification and caching to capture the links that should be investigated.

Threat detection and reporting process 45 may then proceed to action 57 of sub-process 58 to obtain one or more (action 59) whitelists 60 of authorized marks (links), and scan the respective whitelist 60 to identify the mark (link) identified by sub-process 47. When all the links (marks) identified by sub-process 47 are processed (action 61), sub-process 58 may compute and issue a report (action 62) stating a safety status of the received communication (email) 48.

Threat detection and reporting process 45 may then proceed to action 63 of sub-process 64 to compare the links sub-domains to the sub-domains listed in a respective whitelist 60. If a match is found, Threat detection and reporting process 45 may then proceed to sub-process 65.

If the links sub-domain does not match any sub-domain listed in the respective whitelist 60 (action 66) sub-process 60 may compare (action 67) the links domain to the domains listed in a respective whitelist 60. If a match is found (action 68), sub-process 60 may issue a report (action 69) an email threat (yellow alert), for example, according to a respective such as rule 9. If a match is not found, sub-process 60 may issue a report (action 70) of a suspicious email (red alert), for example, according to a respective such as rule 7.

Threat detection and reporting process 45 may then proceed to action 71 of sub-process 65 to further process the link matched in action 66. The sub-domain of this marched link has been found in a respective whitelist. Action 71 may compare the path of the link which sub-domain has been found in a respective whitelist with a whitelisted path as listed in a respective whitelist.

If the comparison does not find a match, sub-process 65 may issue a report (action 72) of a suspicious email (yellow alert), for example, according to a respective such as rule 8.

If the comparison finds a match, and no parameters are found, sub-process 65 may issue a report (action 73) of an authenticated email (green), for example, according to a respective such as rule 1.

If the comparison finds a match, and parameters are found, sub-process 65 may compare the parameters found with authorized parameters listed in a respective whitelist. If the parameters found are listed in the whitelist, sub-process 65 may issue a report (action 74) of an authenticated email (green), for example, according to a respective such as rule 2. If any of the parameters found is not listed in the whitelist, sub-process 65 may issue a report (action 75) of a suspicious email (yellow alert), for example, according to a respective such as rule 3.

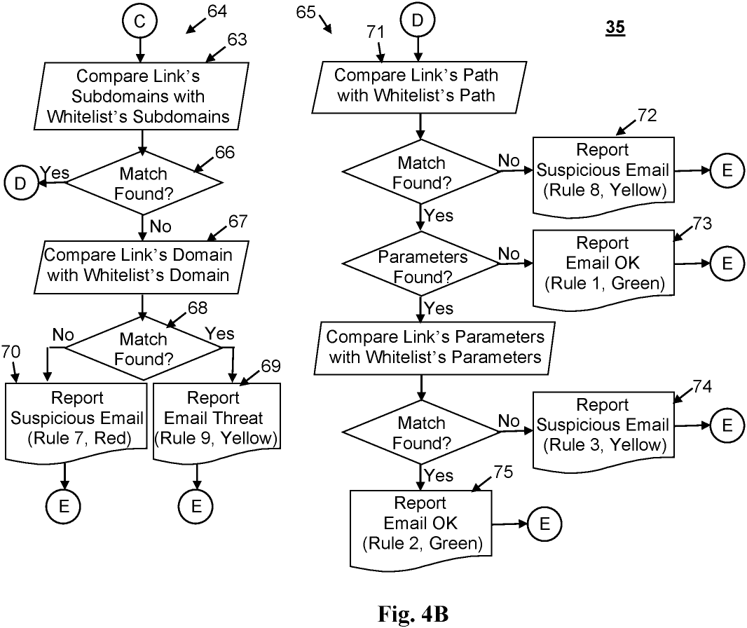

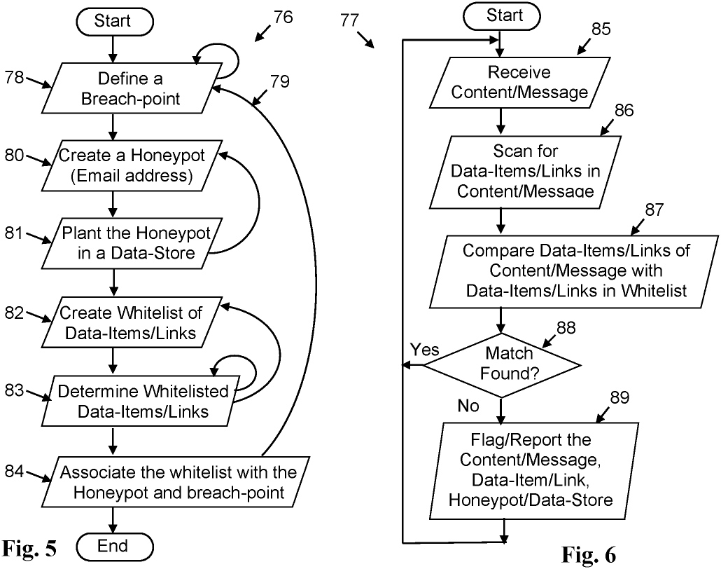

Reference is now made to FIG. 5, which is a simplified flow chart of a preparation routine 76, and to FIG. 6, which is a simplified flow chart of an online processing routine 77, both implemented together to process honeypots to determine compromised data, according to one exemplary embodiment.

As an option, the preparation routine 76 of FIG. 5 and the online processing routine 77 of FIG. 6 may be implemented in the context of the details of the previous figure and/or any subsequent figure(s). Of course, however, the preparation routine 76 and the online processing routine 77 may be implemented in the context of any desired environment. Further, the aforementioned definitions may equally apply to the description below.

As shown in FIG. 5, preparation routine 76 may start with action 78 by creating a breach-point. Action 78 may be repeated to create any number of breach-points. However, usually, after creating a breach-point, a user may proceed to create a honey- pot associated with the breach point, and then to create one or more whitelists associated with the breach-point (and/or honeypot), and then to create another breach-point (action 79).

Preparation process 76 may then proceed to action 80 to create a honeypot and then to action 81 to implant the honeypot in a particular data-store. For example, the honeypot may be a communication address (or messaging address) such as an email address, and the data-store may be an address-book or a mailing-list.

A honeypot may also be a telephone number, for example, for use by a short message service (SMS), a push message service, etc. A honeypot may also be a user ID for use, for example, by an instant messaging service, or a texting service. In this regard, a honeypot may be any software program entity that may receive any type of communicated data or content.

In this regard, a honeypot may be any type of data item that an intruder may obtain for an unauthorized use, and may then be used to identify the unauthorized use as such. Thereafter the particular honeypot and may be used to identify the particular associated breach point as the point of theft. Hence, the particular honeypot and may be used to determine other data and/or content that may have been subject to theft.

Preparation process 76 may then proceed to action 82 to create a whitelist and then to action 83 to determine a data-item/link and include it in the whitelist. Action 83 may be repeated for any number of data-items/links, and actions 82-83 may be repeated for any number of whitelists.

Preparation process 76 may then proceed to action 84 to associate the whitelist with the honeypot and breach-point. However, actions 80-81 may be processed independently of actions 78-82, where actions 78-82 and actions 80-81 form two separate preparation processes.

As shown in FIG. 6, online process 77 may start with action 85 by receiving a piece of content such as a message such as an email message. Typically, the particular piece of content, or message, or email message, is received by online process 77 because it contains a honeypot, such as at least one of the honeypots created and planted in actions 80-81 of preparation process 76.

Online process 77 may then proceed to action 86 to scan the content/message to identify one or more data-items/links in the content/message.

Online process 77 may then proceed to action 87 to compare the data-items/links found in the content/message with data-items/links of at least one whitelist. If no match is found (action 88) online process 77 may flag the associated content/message, and/or data-item/link, and/or honeypot/data-store, as compromised (action 89).

It is appreciated that an intruder may have obtained at least part of the data-store containing a honeypot and has then used the honeypot with the content/message received by online process 77, however, manipulating at least one data-item/link of actions 80-81 of preparation process 76. Thus, at least one of the manipulated links does not appear in any whitelist. The manipulation may include deletion of the data-item/link.

It is appreciated that certain features, which are, for clarity, described in the context of separate embodiments, may also be provided in combination in a single embodiment. Conversely, various features, which are, for brevity, described in the context of a single embodiment, may also be provided separately or in any suitable sub-combination.

Although descriptions have been provided above in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art.

What is claimed is:

1. A computer implemented method comprising:
determining a plurality of first data items, wherein each data item comprises a link to a content item, forming a plurality whitelisted links;
receiving a communicated data item comprising at least one second data item comprising a link to a communicated content item;
comparing said links of said second data items with said plurality whitelisted links; and
flagging said communicated data as an inadequate data if any of said links of said second data items is not within said plurality of whitelisted links.

2. The method according to claim 1, wherein said communicated data is at least one of: an email message, an SMS message, a text message, and a push notification.

3. The method according to claim 1, additionally comprising:
providing a messaging address for receiving at least one message by a first message processing server; and
embedding said messaging address in at least one list of messaging addresses for use by a second message processing server;
wherein said first message processing server is operative to receive said message item being sent by said second message processing server using said list of messaging addresses comprising said messaging address.

4. The method according to claim 1, wherein said action of comparing said links additionally comprises at least one of:
identifying at least one component of said link;
identifying at least one redirection link;
tracing a chain of redirection links; and
adding a redirection link to said plurality whitelisted links.

5. The method according to claim 1, wherein said action of comparing said links additionally comprises at least one of:
obtaining at least one of:
at least one link domain to form at whitelist authorized link domains; and
at least one link sub-domain to form at whitelist authorized link sub-domains; comparing at least one of:
a sub-domain of said link with said sub-domain of said whitelist of authorized sub-domains to form a match; and
a domain of said link with said domain of said whitelist of authorized domains to form a match; and
said flagging said communicated data additionally comprising at least one of:
flagging said sub-domain; and
flagging said domain.

6. A computer program product embodied on a non-transitory computer readable medium, including instructions that, when executed by at least one processor, cause the processor to perform operations comprising:
determining a plurality of first data items, wherein each data item comprises a link to a content item, forming a plurality whitelisted links;
receiving a communicated data item comprising at least one second data item comprising a link to a communicated content item;
comparing said links of said second data items with said plurality whitelisted links; and
flagging said communicated data as an inadequate data if any of said links of said second data items is not within said plurality of whitelisted links.

7. The computer program product according to claim 6, wherein said communicated data is at least one of: an email message, an SMS message, a text message, and a push notification.

8. The computer program product according to claim 6, wherein the operations further comprise:
providing a messaging address for receiving at least one message by a first message processing server; and
embedding said messaging address in at least one list of messaging addresses for use by a second message processing server;
wherein said first message processing server is operative to receive said message item being sent by said second message processing server using said list of messaging addresses comprising said messaging address.

9. The computer program product according to claim 6, wherein said operation of comparing said links additionally comprises at least one of:
identifying at least one component of said link;
identifying at least one redirection link;
tracing a chain of redirection links; and
adding a redirection link to said plurality whitelisted links.

10. The computer program product according to claim 6, wherein said operation of comparing said links additionally comprises at least one of:
obtaining at least one of:
at least one link domain to form at whitelist authorized link domains; and
at least one link sub-domain to form at whitelist authorized link sub-domains; comparing at least one of:
a sub-domain of said link with said sub-domain of said whitelist of authorized sub-domains to form a match; and
a domain of said link with said domain of said whitelist of authorized domains to form a match; and
said flagging said communicated data additionally comprising at least one of:
flagging said sub-domain; and
flagging said domain.

11. A computing equipment comprising at least one processor operative to process software program modules comprising:
a module for determining a plurality of first data items, wherein each data item comprises a link to a content item, forming a plurality whitelisted links;
a module for receiving a communicated data item comprising at least one second data item comprising a link to a communicated content item;
a module for comparing said links of said second data items with said plurality whitelisted links; and
a module for flagging said communicated data as an inadequate data if any of said links of said second data items is not within said plurality of whitelisted links.

12. The computing equipment according to claim 11, wherein said communicated data is at least one of: an email message, an SMS message, a text message, and a push notification.

13. The computing equipment according to claim 11, additionally comprising software program modules comprising:
a module for providing a messaging address for receiving at least one message by a first message processing server; and
a module for embedding said messaging address in at least one list of messaging addresses for use by a second message processing server;
wherein said first message processing server is operative to receive said message item being sent by said second message processing server using said list of messaging addresses comprising said messaging address.

14. The computing equipment according to claim 11, additionally comprising software program modules comprising at least one of:
a module for identifying at least one component of said link;
a module for identifying at least one redirection link;
a module for tracing a chain of redirection links; and
a module for adding a redirection link to said plurality whitelisted links.

15. The computing equipment according to claim 11, additionally comprising software program modules comprising at least one of:
a module for obtaining at least one of:
at least one link domain to form at whitelist authorized link domains; and
at least one link sub-domain to form at whitelist authorized link sub-domains;
a module for comparing at least one of:
a sub-domain of said link with said sub-domain of said whitelist of authorized sub-domains to form a match; and
a domain of said link with said domain of said whitelist of authorized domains to form a match; and
a module for said flagging said communicated data additionally comprising at least one of:
flagging said sub-domain; and
flagging said domain.
